(19) United States
(12) Patent Application Publication
(10) Pub. No.: US 2012/0075093 A1
(43) Pub. Date: Mar. 29, 2012

(54) PORTABLE REMOTE CONTROL DEVICE WITH ANTI-HIDDEN CAMERA AND ANTI-WIRETAPPER FUNCTIONS

(76) Inventor: Sou-Yang CHENG, Tainan City (TW)

(21) Appl. No.: 13/240,388

(22) Filed: Sep. 22, 2011

(30) Foreign Application Priority Data
Sep. 29, 2010 (TW) 099218745
Dec. 1, 2010 (TW) 099223261

(51) Int. Cl. G08B 1/08

(52) U.S. Cl. 340/539.1

(57) ABSTRACT

A portable remote control device with anti-hidden camera and anti-wiretapper functions has a remote controller and a detecting module. The detecting module is mounted in the remote controller. When the detecting module senses wireless signals transmitted from a hidden camera or a wiretapper in surroundings, the detecting module will output a warning message to notify the user. Therefore, the user will note the existence of the illegal apparatus.

### BACKGROUND OF THE INVENTION

1. Field of the Invention

The invention relates, to a remote control device, and more particularly to a portable remote control device with anti-hidden camera and anti-wiretapper functions.

2. Description of Related Art

Spy apparatus such as hidden cameras or wiretappers may be illegally installed in public toilets or rooms in a hotel for stealing private information. Most of the spy apparatus are wireless electronic devices. The hidden cameras or the wiretappers transform the captured private information to wireless signals and transmit the wireless signals to a wireless signal receiver. The private information such as photos or videos may be further spread over the Internet and bring significant damage to the victims.

Although detecting devices for the spy apparatus have been available on the market, the detecting devices have only one function, i.e. sensing the existence of the spy apparatus. If the user goes to an unfamiliar place and wants to check the environment security, he/she must remember to bring the detecting device. However, such detecting device is not frequently used in daily life and may be easily ignored and left behind. Furthermore, the detecting device will occupy a space in the user's bag, personal luggage or pockets.

### SUMMARY OF THE INVENTION

A main objective of the present invention is to provide a portable remote control device with anti-hidden camera and anti-wiretapper functions, which is suitable to be carried around by users.

The portable remote control device includes a remote controller and a detecting module. The detecting module is mounted in the remote controller. When the detecting module senses wireless signals radiated from a hidden camera or a wiretapper, the detecting module will output a warning message to notify the user. Therefore, the user will note the existence of the illegal apparatus in surroundings.

Because the portable device in accordance with the present invention is implemented as a form of a remote controller that is frequently used by most people, the user just needs to use the portable device to detect if there is any illegal apparatus to achieve the purpose of anti-hidden camera and anti-wiretapper. The use of an additional detecting apparatus is avoided and the space for placing the detecting apparatus is saved. Further, the portable remote control device is convenient to be placed in the user's pocket, bag, etc.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a remote control device in accordance with the present invention;

FIG. 2 is an exploded perspective view of the remote control device in FIG. 1;

FIG. 3 is a perspective view of a second preferred embodiment of a remote control device in accordance with the present invention;

FIG. 4 is an exploded perspective view of the remote control device in FIG. 3; and

FIG. 5 is a circuit diagram of a detecting module in the remote control device of the present invention.

### DETAILED DESCRIPTION OF THE PREFERRED EMBODIMENT

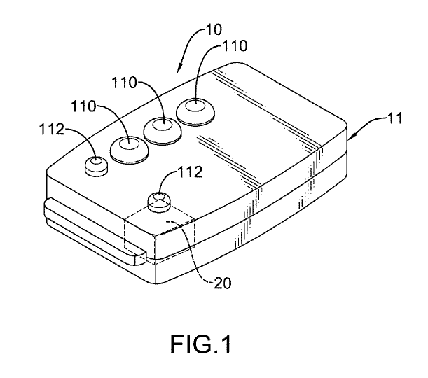

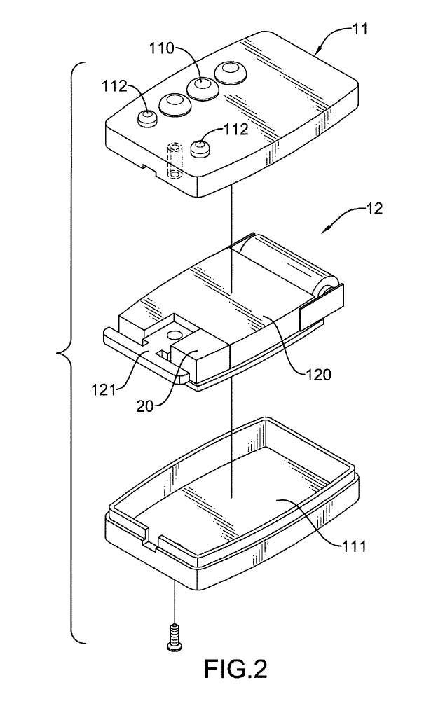

With reference to FIGS. 1 and 2, a first preferred embodiment of a remote control device comprises a remote controller 10 and a detecting module 20.

The remote controller 10 is able to remotely control an electronic locking device for a door, a vehicle or an electronic gate. The remote controller 10 comprises a case 11 and a remote control module 12. The case 11 has an inner space 111, a top surface, multiple function buttons 110 mounted on the top surface, and multiple transparent lids 112. With the user's pressing the function buttons 110, the remote control module 12 outputs control signals to lock or unlock the electronic locking device.

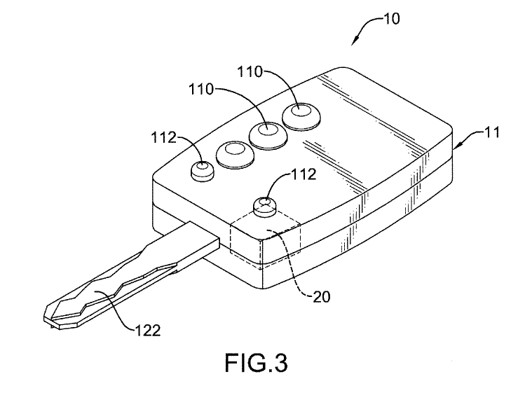

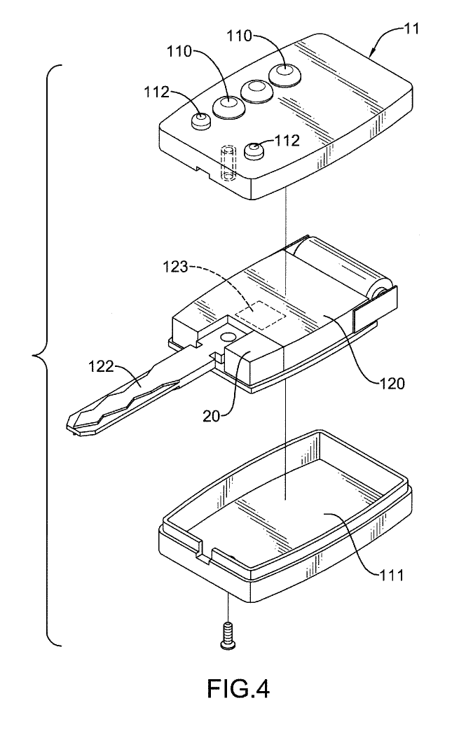

The remote control module 12 is mounted in the inner space 111 and comprises a remote control circuit 120 and a radiation antenna 121 electronically connected to the remote control circuit 120 for radiating the control signals. With further reference to FIGS. 3 and 4, in the second preferred embodiment, the remote control module 12 comprises a remote control circuit 120 and a key 122 protruding from the case 11. The key 122 is connected to the remote control circuit 120 and used as a radiation antenna for transmitting the control signals. The remote control module 12 can further include an auxiliary antenna 123 mounted in the inner space 111 and electrically connected to the remote control circuit 120. Through the auxiliary antenna 123, the control signals output from the remote control module 12 can be made stronger. The key 122 can be made of copper.

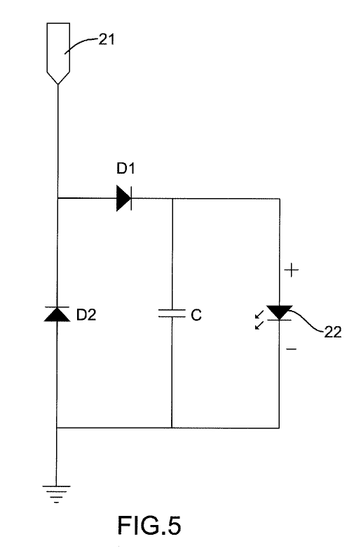

The detecting module 20 is mounted in the remote controller 10. When the detecting module 20 detects wireless signals emitted from a hidden camera or a wiretapper, it generates a warning message. With reference to FIG. 5, the detecting module 20 includes a detecting antenna 21, an LED 22, a first diode D1, a second diode D2, and a capacitor C. The detecting antenna 21 is connected to the LED 22 through the first diode D1. The second diode is reversely connected between the detecting antenna 21 and the ground. The capacitor C is connected between a cathode of the first D1 and the ground and also in parallel to the LED 22. When the detecting antenna 21 detects the wire signals output from the hidden camera or the wiretapper, the detecting antenna 21 produces a current. The current flows through the first diode D1 and drives the LED 22 to emit light as the warning signal. Therefore, the light will be visible from the transparent lids 112 for a user.

Because most people will take a controller for locking or unlocking the vehicle door, the garage gate or the house door when they go out, the remote control device of the present invention is suitable to be carried. The remote control device also provides the anti-spy apparatus function. When the hidden camera or the wiretapper in surroundings are operated and transmit wireless signals to a signal receiver, the detecting antenna 21 will sense the wireless signals and generate a current to drive the LED 22. With the light emitted from the LED 22, the user will easily become aware of the existence of any hidden camera or wiretapper.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable remote control device with anti-hidden camera and anti-wiretapper functions, comprising:
a remote controller for controlling an electronic locking device; and
a detecting module mounted in the remote controller for sensing wireless signals transmitted from a hidden camera or a wiretapper and outputting a warning message when the wireless signals exist.

2. The portable remote control device as claimed in claim 1, wherein the detecting module comprises:
a detecting antenna for sensing the wireless signals of the hidden camera or the wiretapper and outputting a current; and
an LED connected to the detecting antenna and driven by the current to emit light.

3. The portable remote control device as claimed in claim 1, wherein the remote controller comprises:
a case having an inner space, a top surface, multiple function buttons mounted on the top surface and multiple transparent lids mounted on the top surface; and
a remote control module mounted in the inner space and outputting a control signal when any of the function buttons is pressed.

4. The portable remote control device as claimed in claim 2, wherein the remote controller comprises:
a case having an inner space, a top surface, multiple function buttons mounted on the top surface and multiple transparent lids mounted on the top surface; and
a remote control module mounted in the inner space and outputting a control signal when any of the function buttons is pressed.

5. The portable remote control device as claimed in claim 3, wherein the remote control module comprises:
a remote control circuit; and
a radiation antenna electrically connected to the remote control circuit for radiating the control signal.

6. The portable remote control device as claimed in claim 4, wherein the remote control module comprises:
a remote control circuit; and
a radiation antenna electrically connected to the remote control circuit for radiating the control signal.

7. The portable remote control device as claimed in claim 3, wherein the remote control module comprises:
a remote control circuit; and
a key as a radiation antenna electrically connected to the remote control circuit and protruding from the case for radiating the control signal.

8. The portable remote control device as claimed in claim 4, wherein the remote control module comprises:
a remote control circuit; and
a key as a radiation antenna electrically connected to the remote control circuit and protruding from the case for radiating the control signal.

9. The portable remote control device as claimed in claim 7, wherein the remote control module further has an auxiliary antenna mounted in the inner space and electrically connected to the remote control circuit.

10. The portable remote control device as claimed in claim 8, wherein the remote control module further has an auxiliary antenna mounted in the inner space and electrically connected to the remote control circuit.
